(19) United States
(12) Patent Application Publication
(10) Pub. No.: US 2021/0033466 A1
(43) Pub. Date: Feb. 4, 2021

(54) OPTICAL FILTER AND SPECTROMETER INCLUDING THE SAME

(71) Applicant: SAMSUNG ELECTRONICS CO., LTD., Suwon-si (KR)

(72) Inventors: Hyochul KIM, Yongin-si (KR); Younggeun Roh, Seoul (KR); Yeongsang Park, Seoul (KR)

(73) Assignee: SAMSUNG ELECTRONICS CO., LTD., Suwon-si (KR)

(21) Appl. No.: 16/778,164

(22) Filed: Jan. 31, 2020

(30) Foreign Application Priority Data
Jul. 30, 2019 (KR) 10-2019-0092651

(51) Int. Cl. G01J 3/51; G01J 3/18; G02B 5/18; G02B 5/20

(52) U.S. Cl. CPC G01J 3/51; G02B 5/201; G02B 5/18; G01J 3/1895

(57) ABSTRACT

Provided is an optical filter including a plurality of bandpass filters having center wavelengths of light that are different from one another, wherein each of the plurality of bandpass filters includes a cavity layer, a first Bragg reflective layer provided on an upper surface of the cavity layer, and a second Bragg reflective layer provided on a lower surface of the cavity layer opposite to the upper surface, wherein the cavity layer has a thickness greater than A/n, where A is a center wavelength of light of each of the bandpass filters and n is an effective refractive index of the cavity layer, and wherein each of the first Bragg reflective layer and the second Bragg reflective layer includes three or more material layers having different refractive indices from one another.

### CROSS-REFERENCE TO RELATED APPLICATION

This application claims priority to Korean Patent Applications No. 10-2019-0092651, filed on Jul. 30, 2019, in the Korean Intellectual Property Office, the disclosure of which is incorporated herein in its entirety by reference.

### BACKGROUND

### 1. Field

Example embodiments of the present disclosure relate to optical filters and spectrometers including the optical filters.

### 2. Description of Related Art

A spectrometer according to the related art includes various optical devices. As such, the spectrometer may be bulky and heavy. Recently, there has been a need to reduce the size of a spectrometer, and accordingly, research into simultaneous implementation of an integrated circuit and an optical device on one semiconductor chip has been conducted.

### SUMMARY

One or more example embodiments provide optical filters and spectrometers including the optical filters.

Additional aspects will be set forth in part in the description which follows and, in part, will be apparent from the description, or may be learned by practice of the example embodiments.

According to an aspect of an example embodiment, there is provided an optical filter including a plurality of bandpass filters having center wavelengths of light that are different from one another, wherein each of the plurality of bandpass filters includes a cavity layer, a first Bragg reflective layer provided on an upper surface of the cavity layer, and a second Bragg reflective layer provided on a lower surface of the cavity layer opposite to the upper surface, wherein the cavity layer has a thickness greater than λ/n, where, λ is a center wavelength of light of each of the bandpass filters and n is an effective refractive index of the cavity layer, and wherein each of the first Bragg reflective layer and the second Bragg reflective layer includes three or more material layers having different refractive indices from one another.

The cavity layer may include one material layer or a plurality of material layers having different refractive indices from one another.

The plurality of material layers may be provided horizontally or vertically.

The plurality of material layers may be provided one-dimensionally or two-dimensionally.

Each of the first Bragg reflective layer and the second Bragg reflective layer may include a first material layer including silicon, a second material layer including silicon oxide, and a third material layer including titanium oxide or titanium nitride.

The optical filter may further include a plurality of additional filters provided on the plurality of bandpass filters, the plurality of additional filters being configured to transmit light of certain wavelength bands, respectively.

The plurality of additional filters may include a plurality of color filters.

The plurality of additional filters may include a plurality of wideband filters.

Each of the plurality of wideband filters may have a multi-cavity structure or a metal mirror structure.

Each of the plurality of additional filters may correspond to at least one of the bandpass filters.

According to an aspect of an example embodiment, there is provided an optical filter including a plurality of bandpass filters having center wavelengths of light that are different from one another, wherein each of the plurality of bandpass filters includes a cavity layer, a first Bragg reflective layer provided on an upper surface of the cavity layer, and a second Bragg reflective layer provided on a lower surface of the cavity layer opposite to the upper surface, wherein the cavity layer has a thickness greater than λ/n, where, λ is a center wavelength of light of each of the bandpass filters and n is an effective refractive index of the cavity layer.

The optical filter may further include a plurality of additional filters provided on the plurality of bandpass filters, the plurality of additional filters configured to transmit light of certain wavelength bands, respectively.

The plurality of additional filters may include a plurality of color filters or a plurality of wideband filters.

According to an aspect of an example embodiment, there is provided a spectrometer including an optical filter including a plurality of bandpass filters having center wavelengths of light that are different from one another, and a sensing device configured to receive light transmitted through the optical filter, wherein each of the plurality of bandpass filters includes a cavity layer, a first Bragg reflective layer provided on an upper surface of the cavity layer, and a second Bragg reflective layer provided on a lower surface of the cavity layer opposite to the upper surface, wherein the cavity layer has a thickness greater than λ/n, where λ is a center wavelength of light of each of the bandpass filters and n is an effective refractive index of the cavity layer, and wherein each of the first Bragg reflective layer and the second Bragg reflective layer includes three or more material layers having different refractive indices from one another.

The optical filter may further include a plurality of additional filters provided on the plurality of bandpass filters, the plurality of additional filters being configured to transmit certain wavelength bands of light, respectively.

The plurality of additional filters may include a plurality of color filters or a plurality of wideband filters.

The sensing device may include an image sensor or a photodiode.

According to an aspect of an example embodiment, there is provided a spectrometer including an optical filter including a plurality of bandpass filters having center wavelengths of light that are different from one another, and a sensing device configured to receive light transmitted through the optical filter, wherein each of the plurality of bandpass filters includes a cavity layer, a first Bragg reflective layer provided on an upper surface of the cavity layer, and a second Bragg reflective layer provided on a lower surface of the cavity layer opposite to the upper surface, wherein the cavity layer has a thickness greater than λ/n, where λ denotes a center wavelength of light of each of the bandpass filters and n is an effective refractive index of the cavity layer.

The optical filter may further include a plurality of additional filters provided on the plurality of bandpass filters, the plurality of additional filters configured to transmit certain wavelength bands of light, respectively.

The plurality of additional filters may include a plurality of color filters or a plurality of wideband filters.

The plurality of material layers may include a first material layer and a second material layer that are alternately provided horizontally, and a refractive index of the first material layer is different from a refractive index of the second material layer.

The plurality of material layers may include a first material layer and a second material layer that are alternately provided horizontally, and a refractive index of the first material layer is different from a refractive index of the second material layer.

Three adjacent bandpass filters among the plurality of bandpass filters may be included in a filter array, and each of the plurality of additional filters correspond to the filter array.

### BRIEF DESCRIPTION OF THE DRAWINGS

The above and/or other aspects, features, and advantages of example embodiments of the disclosure will be more apparent from the following description taken in conjunction with the accompanying drawings, in which:

FIG. 1 is a perspective view of a spectrometer according to an example embodiment;

FIG. 2 is a cross-sectional view of a bandpass filter in an optical filter of FIG. 1;

FIG. 3 is a diagram showing transmission spectrum of a bandpass filter according to the related art and transmission spectrum of the bandpass filter of FIG. 2;

FIG. 4 is a cross-sectional view of a bandpass filter according to another example embodiment;

FIG. 5 is a cross-sectional view of a bandpass filter according to another example embodiment;

FIG. 6 is a cross-sectional view of an optical filter according to another example embodiment;

FIG. 7A is a diagram showing transmission spectrums of light transmitting through a first filter array (blue filter array) of FIG. 6;

FIG. 7B is a diagram showing transmission spectrums of light transmitting through a second filter array (green filter array) of FIG. 6;

FIG. 7C is a diagram showing transmission spectrums of light transmitting through a third filter array (red filter array) of FIG. 6;

FIG. 8 is a diagram showing transmission spectrums of light transmitting through first, second, and third color filters of FIG. 6;

FIG. 9A is a diagram of transmission spectrums of light transmitting through the first color filter and the first filter array of FIG. 6;

FIG. 9B is a diagram of transmission spectrums of light transmitting through the second color filter and the second filter array of FIG. 6;

FIG. 9C is a diagram of transmission spectrums of light transmitting through the third color filter and the third filter array of FIG. 6;

FIG. 10 is a cross-sectional view of an optical filter according to another example embodiment;

FIG. 11 is a diagram showing an example of a wideband filter of FIG. 10;

FIG. 12 is a diagram showing another example of the wideband filter of FIG. 10;

FIG. 13A is a diagram of transmission spectrums of light transmitting through the first filter array of FIG. 10;

FIG. 13B is a diagram of transmission spectrums of light transmitting through the second filter array of FIG. 10;

FIG. 13C is a diagram of transmission spectrums of light transmitting through the third filter array of FIG. 10;

FIG. 14 is a diagram showing transmission spectrums of light transmitting through first, second, and third wideband filters of FIG. 10;

FIG. 15A is a diagram of transmission spectrums of light transmitting through the first wideband filter and the first filter array of FIG. 10;

FIG. 15B is a diagram of transmission spectrums of light transmitting through the second wideband filter and the second filter array of FIG. 10; and

FIG. 15C is a diagram of transmission spectrums of light transmitting through the third wideband filter and the third filter array of FIG. 10.

### DETAILED DESCRIPTION

Reference will now be made in detail to example embodiments of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

When a layer, a film, a region, or a panel is referred to as being “on” another element, it may be directly on the other layer or substrate, or intervening layers may also be present. An expression used in the singular encompasses the expression of the plural, unless it has a clearly different meaning in the context. Throughout the specification, when a portion “includes” an element, another element may be further included, rather than excluding the existence of the other element, unless otherwise described.

As used herein, in particular, terms such as “the” and demonstratives similar thereto used herein may be to indicate both the singular and the plural. Also, the steps of all methods described herein may be performed in any suitable order unless otherwise indicated herein or otherwise clearly contradicted by context. The present disclosure is not limited to the described order of the steps. The use of any and all examples, or example language provided herein, is intended merely to better illuminate the present disclosure and does not pose a limitation on the scope of the present disclosure unless otherwise claimed.

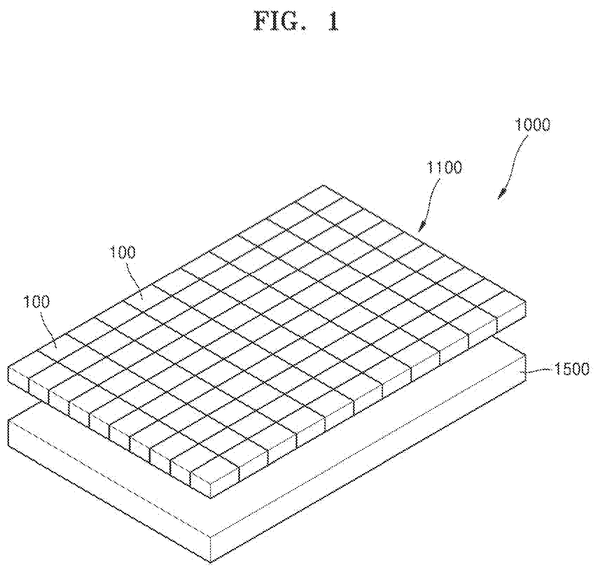

FIG. 1 is a perspective view of a spectrometer 1000 according to an example embodiment.

Referring to FIG. 1, the spectrometer 1000 includes a sensing device 1500 and an optical filter 1100 provided on the sensing device 1500. The optical filter 1100 may include a plurality of bandpass filters 100 arranged two-dimensionally. However, embodiments are not limited thereto. For example, the plurality of bandpass filters 100 may be arranged one-dimensionally.

Each of the plurality of bandpass filters 100 may transmit a certain wavelength band of light. Here, the plurality of bandpass filters 100 may have different center wavelengths of light from one another. However, embodiments are not limited thereto. For example, some of the plurality of bandpass filters 100 may have the same center wavelength of light as one another.

The sensing device 1500 may receive light that has passed through the optical filter 1100 and convert the light into an electric signal. The light incident into the optical filter 1100 passes through the plurality of bandpass filters 100, and the light having different center wavelengths passing through the bandpass filters 100 reaches pixels of the sensing device 1500. The sensing device 1500 converts the light incident to the pixels into electric signals to perform spectroscopy on the light incident to the optical filter 1100. The sensing device 1500 may include, for example, an image sensor such as a charge-coupled device (CCD), a complementary metal oxide semiconductor (CMOS) image sensor, etc., or a photodiode. However, embodiments are not limited thereto.

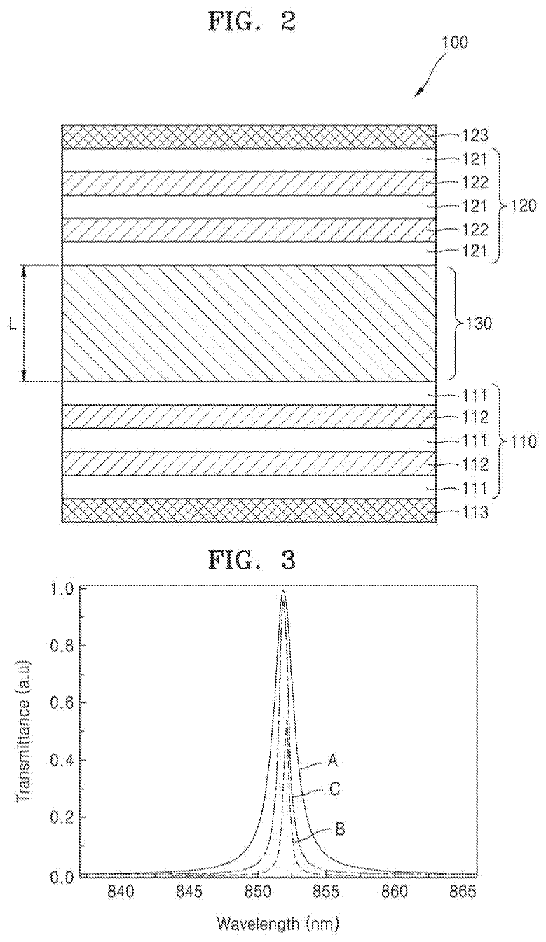

FIG. 2 is a cross-sectional view of a bandpass filter 100 of the optical filter 1100 of FIG. 1.

Referring to FIG. 2, the bandpass filter 100 transmits a wavelength band of light including a certain center wavelength and has a Fabry-Perot structure, in which a resonant layer is provided between two reflective layers. A center wavelength and a wavelength band of the light passing through a bandpass filter may be determined according to reflection bands of the reflective layers and characteristics of a cavity layer.

For example, the bandpass filter 100 includes a first Bragg reflective layer 110 and a second Bragg reflective layer 120, and a cavity layer 130 between the first and second Bragg reflective layers 110 and 120, where the first and second Bragg reflective layers 110 and 120 are spaced apart from each other.

The cavity layer 130 may be a resonant layer, and may include a semiconductor material having a predetermined refractive index. For example, the cavity layer 130 may include silicon or silicon oxide. However, embodiments are not limited thereto. For example, the cavity layer 130 may include various materials according to design conditions such as a wavelength of incident light, etc.

When the light is incident to the cavity layer 130 from an upper surface of the bandpass filter 100, the light reciprocates in the cavity layer 130 between the first and second Bragg reflective layers 110 and 120 and causes constructive interference and destructive interference. In addition, the light having a certain center wavelength that satisfies the constructive interference condition is output from a lower surface of the bandpass filter 100.

In general, an intensity of the light emitted from the bandpass filter 100 may vary depending on an incident angle of the light incident to the bandpass filter 100. In order to reduce dependency of the light on the incident angle, the cavity layer 130 may have a thickness equal to or greater than a predetermined thickness according to the embodiment.

For example, the cavity layer 130 may have a thickness L that is greater than λ/n, where, λ denotes a center wavelength of the bandpass filter 100 and n denotes an effective refractive index of the cavity layer 130. As described above, when the thickness L of the cavity layer 130 is greater than λ/n, the light of a desired intensity having a certain center wavelength may be transmitted even when the light is incident to the bandpass filter 100 at various angles.

Each of the first and second Bragg reflective layers 110 and 120 respectively provided on lower and upper surfaces of the cavity layer 130 may be a distributed Bragg reflector (DBR). For example, each of the first and second Bragg reflective layers 110 and 120 may include three material layers having different refractive indices from one another.

For example, the first Bragg reflective layer 110 may have a structure, in which at least one first material layer 111, at least one second material layer 112, and at least one third material layer 113 are sequentially stacked in a vertical direction. FIG. 2 shows an example of a structure of the first Bragg reflective layer 110, in which three first material layers 111 and two second material layers 112 are alternately stacked in the vertical direction on an upper surface of the third material layer 113. However, the number and arrangement of the first to third material layers 111, 112, and 113 may be variously modified.

The first to third material layers 111, 112, and 113 may have materials having different refractive indices from one another. For example, the first material layer 111 may have a maximum refractive index and the second material layer 112 may have a minimum refractive index. In addition, a refractive index of the third material layer 113 may be less than that of the first material layer 111 and greater than that of the second material layer 112.

For example, the first material layer 111 may include silicon and the second material layer 112 may include silicon oxide. In addition, the third material layer 113 may include titanium oxide or titanium nitride. Here, silicon may have a refractive index of about 3.0 or greater, silicon oxide may have a refractive index of about 1.4 to 1.5, and titanium oxide or titanium nitride may have a refractive index of about 1.9 to 3.0.

The second Bragg reflective layer 120 may have a structure, in which at least one first material layer 121, at least one second material layer 122, and at least one third material layer 123 are stacked in a vertical direction, similar to the first Bragg reflective layer 110. FIG. 2 shows an example of a structure of the second Bragg reflective layer, in which three first material layers 121 and two second material layers 122 are alternately stacked in the vertical direction on a lower surface of the third material layer 123, but embodiments are not limited thereto. For example, the number and arrangement of the first to third material layers 121, 122, and 123 may be variously modified.

The first to third material layers 121, 122, and 123 may have materials having different refractive indices from one another. For example, the first material layer 121 may have a maximum refractive index and the second material layer 122 may have a minimum refractive index. In addition, a refractive index of the third material layer 123 may be less than that of the first material layer 121 and greater than that of the second material layer 122. For example, the first material layer 121 may include silicon and the second material layer 122 may include silicon oxide. In addition, the third material layer 123 may include titanium oxide or titanium nitride.

In the example embodiment, the first and second Bragg reflective layers 110 and 120 respectively include three material layers, that is, the first material layers 111 and 121, the second material layers 112 and 122, and the third material layers 131 and 132, and thus a width of a wavelength band of light passing through the bandpass filter 100, for example, full width at half maximum (FWHM) may be adjusted to have a desired value.

In a bandpass filter according to the related art, two first and second material layers that have different refractive indices from each other which are alternately stacked are used as the Bragg reflective layer. Here, the width of the wavelength band of light is determined by adjusting the numbers of first and second material layers. For example, when the number of each of the first and second material layers is n, the width of the wavelength band of light may be w1. In addition, when the number of each of the first and second material layers is n+1, the width of the wavelength band of light may be w2. Therefore, in the bandpass filter according to the related art, the wavelength band of light having a width between w1 and w2 may not be implemented.

In the example embodiment, the first and second Bragg reflective layers 110 and 120 in the bandpass filter 100 respectively include three material layers, for example, the first material layers 111 and 121, the second material layers 121 and 122, and the third material layers 131 and 132 having different refractive indices from one another. Thus, the wavelength band of light having a width between w1 and w2 may be implemented.

FIG. 3 is a diagram showing transmission spectrums of a bandpass filter according to the related art and transmission spectrums of the bandpass filter unit 100 of FIG. 2. Here, the first and second material layers in the Bragg reflective layer in the bandpass filter according to the related art include silicon and silicon oxide, and the first to third material layers included in the first and second Bragg reflective layers 110 and 120 of the bandpass filter 100 shown in FIG. 2 according to the example embodiment include silicon, silicon oxide, and titanium oxide.

In FIG. 3, λ denotes a transmission spectrum in a case in which the wavelength band of light has a width w1 when the number of each of the first and second material layers is n in the bandpass filter according to the related art. In addition, B denotes a transmission spectrum in a case in which the wavelength band of light has a width w2 (<w1) when the number of each of the first and second material layers is n+1 in the bandpass filter according to the related art. Also, C denotes a transmission spectrum in a case in which the wavelength band of light has a width w (w2<w<w1) in the bandpass filter 100 according to the example embodiment illustrated with reference to FIG. 2. As shown in FIG. 3, in the bandpass filter 100 according to the example embodiment, the first and second Bragg reflective layers 110 and 120 respectively include three material layers, that is, the first material layers 111 and 121, the second material layers 112 and 122, and the third material layers 131 and 132 having different refractive indices from one another. Thus, the wavelength band of light having a width between w1 and w2 may be implemented.

In the above description, the first and second Bragg reflective layers 110 and 120 respectively include three material layers having different refractive indices from one another. However, embodiments are not limited thereto. For example, each of the first and second Bragg reflective layers 110 and 120 may include four or more material layers having different refractive indices from one another.

As described above, since the first and second Bragg reflective layers 110 and 120 respectively include three or more material layers having different refractive indices from one another, the width of the wavelength band of light passing through the bandpass filter 100 may be variously adjusted.

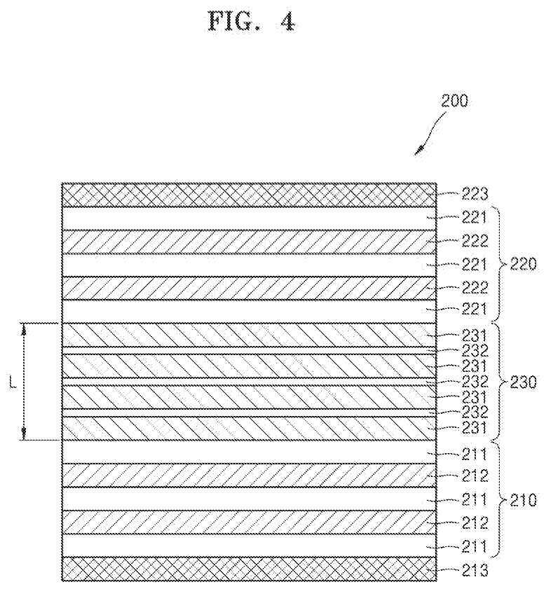

FIG. 4 is a cross-sectional view of a bandpass filter 200 according to an example embodiment.

Referring to FIG. 4, the bandpass filter 200 includes first and second Bragg reflective layers 210 and 220, and a cavity layer 230 between the first Bragg reflective layer 210 and the second Bragg reflective layer 220, where the first and second Bragg reflective layers 210 and 220 are spaced apart from each other.

The cavity layer 230 may include at least one first material layer 231 and at least one second material layers 232 having different refractive indices from each other. Here, the at least one first material layer 231 and the at least one second material layer 232 may be alternately stacked in the vertical direction. FIG. 4 shows an example, in which three first material layers 231 and three second material layers 232 are alternately stacked. However, the number of first material layers 231 and the number of second material layers 232 are not limited thereto, and may be modified variously.

The first and second material layers 231 and 232 may include materials having different refractive indices from each other. For example, the first material layer 231 may include silicon and the second material layer 232 may include silicon oxide. However, embodiments are not limited thereto. For example, the first and second material layers 231 and 232 may include various other materials.

In the above description, the cavity layer 230 includes two material layers. For example, the first and second material layers 231 and 232 having different refractive indices from each other and being stacked in the vertical direction are included in the cavity layer 230. However, embodiments are not limited thereto. For example, the cavity layer 230 may include three or more material layers having different refractive indices from one another and being stacked in the vertical direction.

The cavity layer 230 may have a thickness L that is greater than λ/n, where, λ denotes a center wavelength of the bandpass filter 100 and n denotes an effective refractive index of the cavity layer 130. As described above, when the thickness L of the cavity layer 230 is greater than λ/n, the light of a desired intensity having a certain center wavelength may be transmitted even when the light is incident to the bandpass filter 200 at various angles.

The first and second Bragg reflective layers 210 and 220 are respectively provided on lower and upper surfaces of the cavity layer 230, and each of the first and second Bragg reflective layers 210 and 220 may include three material layers having different refractive indices from one another.

In detail, the first Bragg reflective layer 210 has a structure, in which at least one first material layer 211, at least one second material layer 212, and at least one third material layer 213 are stacked in a vertical direction. However, the number and arrangement of the first to third material layers 211, 212, and 213 may be variously modified. The first to third material layers 211, 212, and 213 may have materials having different refractive indices from one another.

The second Bragg reflective layer 220 may have a structure, in which at least one first material layer 221, at least one second material layer 222, and at least one third material layer 223 are stacked in a vertical direction, similar to the first Bragg reflective layer 210. The number and arrangement of the first to third material layers 221, 222, and 223 may be variously modified. The first to third material layers 221, 222, and 223 may have materials having different refractive indices from one another.

In the above description, the first and second Bragg reflective layers 210 and 220 respectively include three material layers having different refractive indices from one another, but the first and second Bragg reflective layers 210 and 220 may respectively include four or more material layers having different refractive indices from one another. Accordingly, the width of the wavelength band of light passing through the bandpass filter 200 may be variously adjusted.

FIG. 5 is a cross-sectional view of a bandpass filter 300 according to an example embodiment.

Referring to FIG. 5, the bandpass filter 300 includes first and second Bragg reflective layers 310 and 320, and a cavity layer 330 between the first Bragg reflective layer 310 and the second Bragg reflective layer 320, where the first and second Bragg reflective layers 310 and 320 are spaced apart from each other.

The cavity layer 330 may include at least one first material layer 331 and at least one second material layers 332 having different refractive indices from each other. For example, the at least one first material layer 331 and the at least one second material layer 332 may be alternately stacked in a horizontal direction. Here, the numbers of first and second material layers 331 and 332 may be variously modified.

The first and second material layers 331 and 332 may include materials having different refractive indices from each other. For example, the first material layer 331 may include silicon and the second material layer 332 may include silicon oxide. However, embodiments are not limited thereto. For example, the first and second material layers 331 and 332 may include various other materials.

In the above description, the cavity layer 330 includes two material layers, that is, the first and second material layers 331 and 332 having different refractive indices from each other and being arranged in the horizontal direction. However, embodiments are not limited thereto, and the cavity layer 330 may include three or more material layers having different refractive indices from one another and being arranged in the horizontal direction.

The cavity layer 330 may have a thickness L that is greater than λ/n, where, λ denotes a center wavelength of the bandpass filter 300 and n denotes an effective refractive index of the cavity layer 330. As described above, when the thickness L of the cavity layer 330 is greater than λ/n, the light of a desired intensity having a certain center wavelength may be transmitted even when the light is incident to the bandpass filter 300 at various angles.

The first and second Bragg reflective layers 310 and 320 are on lower and upper surfaces of the cavity layer 330, and each of the first and second Bragg reflective layers 310 and 320 may include three material layers having different refractive indices from one another.

For example, the first Bragg reflective layer 310 has a structure, in which at least one first material layer 311, at least one second material layer 312, and at least one third material layer 313 are stacked in a vertical direction. However, the number and arrangement of the first to third material layers 311, 312, and 313 may be variously modified. The first to third material layers 311, 312, and 313 may have materials having different refractive indices from one another.

The second Bragg reflective layer 320 may have a structure, in which at least one first material layer 321, at least one second material layer 322, and at least one third material layer 323 are stacked in a vertical direction, similar to the first Bragg reflective layer 310. The number and arrangement of the first to third material layers 321, 322, and 323 may be variously modified. The first to third material layers 321, 322, and 323 may have materials having different refractive indices from one another.

In the above description, the first and second Bragg reflective layers 310 and 320 respectively include three material layers having different refractive indices from one another, but the first and second Bragg reflective layers 310 and 320 may respectively include four or more material layers having different refractive indices from one another. Accordingly, the width of the wavelength band of light passing through the bandpass filter 300 may be variously adjusted.

Hereinafter, examples in which light of a desired wavelength band of light is only incident to the bandpass filter by using an additional filter such as a color filter unit, a wideband filter unit, etc. will be described below.

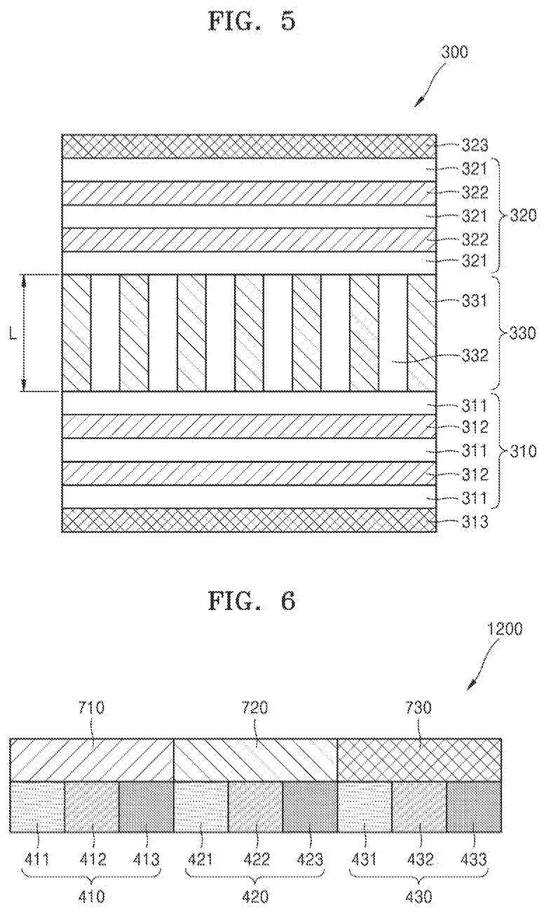

FIG. 6 is a cross-sectional view of an optical filter 1200 according to an example embodiment.

Referring to FIG. 6, the optical filter 1200 includes a plurality of bandpass filters 411, 412, 413, 421, 422, 423, 431, 432, and 433 and a plurality of color filters 710, 720, and 730 on upper portions of the bandpass filters 411 to 433, wherein the plurality of bandpass filters 411 to 433 having different center wavelengths of light from one another are arranged in a predetermined pattern. Here, each of the plurality of bandpass filters 411 to 433 may include one of the bandpass filters 100, 200, and 300 of the Fabry-Perot structure described in the above example embodiments.

FIG. 6 shows an example, in which nine bandpass filters 411 to 433 having different center wavelengths of light from one another are provided, and three bandpass filters having adjacent peak wavelengths configure one filter array 410, 420, or 430. The number of bandpass filters configuring one filter array 410, 420, or 430 may be variously modified. For example, one bandpass filter may configure one filter array 410, 420, or 430.

The first filter array 410 may include first bandpass filter 411, the second bandpass filter 412, and the third bandpass filter 413 arranged adjacent to one another. The first to third bandpass filters 411, 412, and 413 may have adjacent center wavelengths of light to one another. The first filter array 410 may transmit a first wavelength band of light. Here, the first wavelength band of light may be determined by the wavelength bands of light of the first to third bandpass filters 411, 412, and 413.

The second filter array 420 may include fourth to sixth bandpass filters 421, 422, and 423 arranged adjacent to one another. The fourth to sixth bandpass filters 421, 422, and 423 may have adjacent center wavelengths of light to one another. The second filter array 420 may transmit a second wavelength band of light. Here, the second wavelength band of light may be determined by the wavelength bands of light of the fourth to sixth bandpass filters 421, 422, and 423.

The third filter array 430 may include seventh, eighth, and ninth filters 431, 432, and 433 arranged adjacent to one another. The seventh to ninth bandpass filters 431, 432, and 433 may have adjacent center wavelengths of light to one another. The third filter array 430 may transmit a third wavelength band of light. Here, the third wavelength band of light may be determined by the wavelength bands of light of the seventh to ninth bandpass filters 431, 432, and 433.

For example, when the optical filter 1200 having a wavelength band of light of about 400 nm to 700 nm (visible ray wavelength band of light) is to be manufactured, the first filter array 410 may be a blue filter array that transmits a first wavelength band of light of about 400 nm to 500 nm. Here, the first wavelength band of light of about 400 nm to 500 nm is divided into three bands, which are the wavelength bands of light of the first, second, and third bandpass filters 411, 412, and 413.

The second filter array 420 may be a green filter array that transmits a second wavelength band of light of about 500 nm to 600 nm. Here, the second wavelength band of light of about 500 nm to 600 nm is divided into three bands, which are the wavelength bands of light of the fourth, fifth, and sixth bandpass filters 421, 422, and 423. The third filter array 430 may be a red filter array that transmits a third wavelength band of light of about 600 nm to 700 nm. Here, the third wavelength band of light of about 600 nm to 700 nm is divided into three bands, which are the wavelength bands of light of the seventh, eighth, and ninth bandpass filters 431, 432, and 433.

The plurality of color filters 710, 720, and 730 having different colors are provided on upper portions of the plurality of first to ninth bandpass filters 411 to 433. Here, the plurality of color filters 710, 720, and 730 may block the light of a wavelength band that is not the target of corresponding filter arrays 410, 420, and 430, as described later. The plurality of color filters 710, 720, and 730 may be generally applied to a color display apparatus such as a liquid crystal display apparatus, an organic light-emitting display apparatus, etc.

The plurality of color filters 710, 720, and 730 may correspond to the plurality of first to third filter arrays 410, 420, and 430, respectively. FIG. 6 shows an example, in which three color filters, that is, first to third color filters 710, 720, and 730 correspond to the first to third filter arrays 410, 420, and 430.

The first color filter 710 is provided on an upper portion of the first filter array 410 including the first to third bandpass filters 411, 412, and 413. For example, when the first filter array 410 is the blue filter array transmitting the wavelength band of light of about 400 nm to 500 nm, the first color filter 710 may be a blue color filter that transmits the wavelength band of blue light.

The second color filter 720 is provided on an upper portion of the second filter array 420 including the fourth sixth bandpass filters 421, 422, and 423. For example, when the second filter array 420 is the green filter array transmitting the wavelength band of light of about 500 nm to 600 nm, the second color filter 720 may be a green color filter that transmits the wavelength band of green light.

The third color filter 730 is provided on an upper portion of the third filter array 430 including the seventh to ninth bandpass filters 431, 432, and 433. For example, when the third filter array 430 is the red filter array transmitting the wavelength band of light of about 600 nm to 700 nm, the third color filter 730 may be a red color filter that transmits the wavelength band of red light.

The first, second, and third color filters 710, 720, and 730 may prevent or reduce the light of wavelength bands that are not the targets of the first to third filter arrays 410, 420, 430 from being incident to the first to third filter arrays 410, 420, and 430.

In general, in the bandpass filter of the Fabry-Perot structure, the wavelength band of light passing through the bandpass filter is determined according to reflection bands of the reflective layers and characteristics of the cavity layer. However, the light of another wavelength band, as well as the target wavelength band of light, may also transmit through the bandpass filter due to a low-reflective portion in the reflective layer and influence of the sideband, etc.

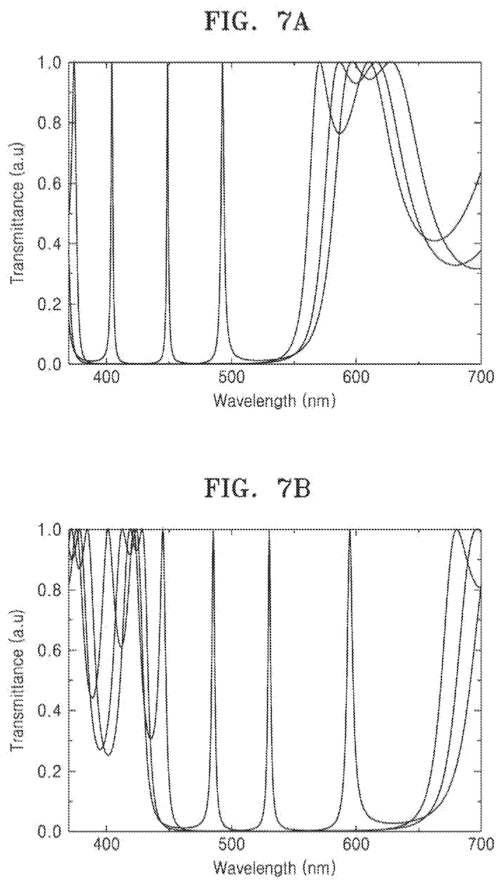

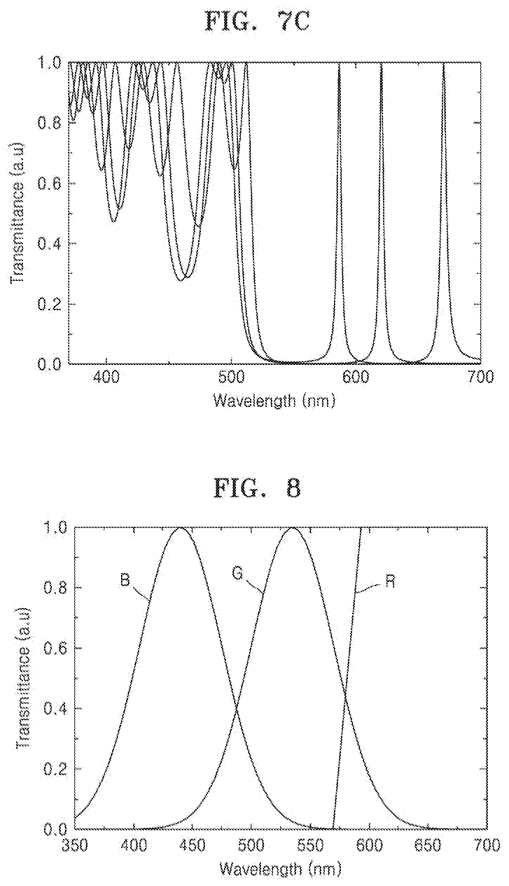

FIG. 7A shows a transmission spectrum of the light passing through the first filter array 410 in a case in which the first filter array 410 including the first to third bandpass filters 411, 412, and 413 of FIG. 6 is manufactured as the blue filter array that transmits light of the wavelength band of about 400 nm to 500 nm. Referring to FIG. 7A, it is understood that the light of other wavelength bands than the blue wavelength band that is the target of the first filter array 410 has passed through the first filter array 410.

FIG. 7B shows a transmission spectrum of the light passing through the second filter array 420 in a case in which the second filter array 420 including the fourth to sixth bandpass filters 421, 422, and 423 of FIG. 6 is manufactured as the green filter array that transmits light of the wavelength band of about 500 nm to 600 nm. Referring to FIG. 7B, it is understood that the light of other wavelength bands than the green wavelength band that is the target of the second filter array 420 has passed through the second filter array 420.

FIG. 7C shows a transmission spectrum of the light passing through the third filter array 430 in a case in which the third filter array 430 including the seventh to ninth bandpass filters 431, 432, and 433 of FIG. 6 is manufactured as the red filter array that transmits light of the wavelength band of about 600 nm to 700 nm. Referring to FIG. 7C, it is understood that the light of other wavelength bands than the red wavelength band that is the target of the third filter array 430 has passed through the third filter array 430.

In the example embodiment, the first color filter 710 provided on the upper portion of the first filter array 410 may block the light of the wavelength band that is not the target of the first filter array 410, for example, light of other wavelength bands than the first wavelength band. In addition, the second color filter 720 provided on the upper portion of the second filter array 420 may block the light of the wavelength band that is not the target of the second filter array 420, for example, light of other wavelength bands than the second wavelength band. In addition, the third color filter 730 provided on the upper portion of the third filter array 430 may block the light of the wavelength band that is not the target of the third filter array 430, for example, light of other wavelength bands than the third wavelength band.

FIG. 8 shows transmission spectrums of the light passing through the first to third color filters 710, 720, and 730 when the first to third color filters 710, 720, and 730 are respectively the blue, green, and red color filters in FIG. 6. In FIG. 8, B, G, and R respectively denote the transmission spectrums of the light passing through the first, second, and third color filters 710, 720, and 730.

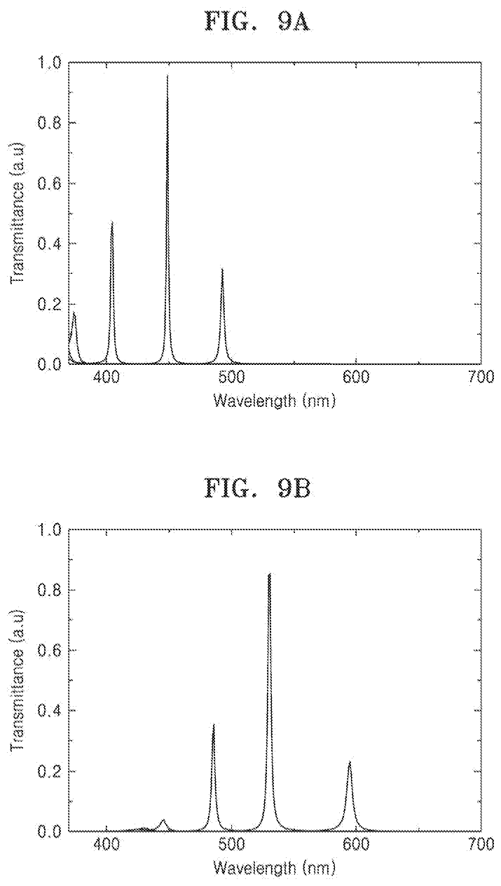

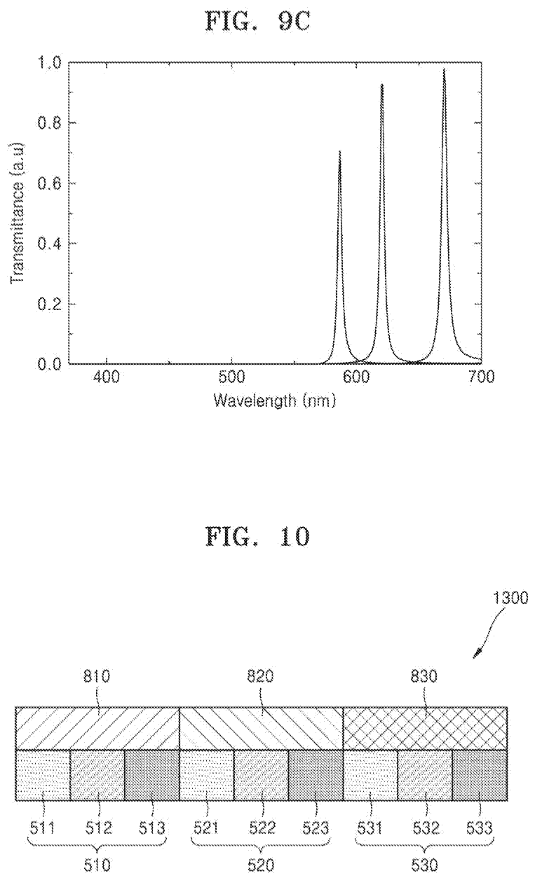

FIG. 9A shows transmission spectrums of the light passing through the first color filter 710 and the first filter array 410 when the first color filter (blue color filter unit) 710 having the transmission spectrums shown in FIG. 8 is provided on the upper portion of the first filter array (blue filter array) 410 having the transmission spectrums shown in FIG. 7A.

Referring to FIG. 9A, the light of other wavelength bands than the blue wavelength bands is blocked by the first color filter 710 and the light of the blue wavelength band is only incident to the first filter array 410, and thus the transmission spectrums of the first wavelength band of light that is the target of the first filter array 410 may be obtained. FIG. 9A shows the transmission spectrums of the first to third bandpass filters 411, 412, and 413 within the first wavelength band of light of the first filter array 410.

FIG. 9B shows transmission spectrums of the light passing through the second color filter 720 and the second filter array 420 when the second color filter (green color filter unit) 720 having the transmission spectrums shown in FIG. 8 is provided on the upper portion of the second filter array (green filter array) 420 having the transmission spectrums shown in FIG. 7B.

Referring to FIG. 9B, the light of other wavelength bands than the green wavelength bands is blocked by the second color filter 720 and the light of the green wavelength band is only incident to the second filter array 420, and thus the transmission spectrums of the second wavelength band of light that is the target of the second filter array 420 may be obtained. FIG. 9B shows the transmission spectrums of the fourth to sixth bandpass filters 421, 422, and 423 within the second wavelength band of light of the second filter array 420.

FIG. 9C shows transmission spectrums of the light passing through the third color filter 730 and the third filter array 430 when the third color filter (red color filter unit) 730 having the transmission spectrums shown in FIG. 8 is provided on the upper portion of the third filter array (red filter array) 430 having the transmission spectrums shown in FIG. 7C.

Referring to FIG. 9C, the light of other wavelength bands than the red wavelength bands is blocked by the third color filter 730 and the light of the red wavelength band is only incident to the third filter array 430, and thus the transmission spectrums of the third wavelength band of light that is the target of the third filter array 430 may be obtained. FIG. 9C shows the transmission spectrums of the seventh to ninth filters 431, 432, and 433 within the third wavelength band of light of the third filter array 430.

As described above, in the optical filter 1200 according to the example embodiment, the color filters 710, 720, and 730 that only transmit the light of certain wavelength bands are provided on the bandpass filters 411 to 433 so that the light of the desired wavelength bands may be only incident to the bandpass filters 411 to 433, and accordingly, the spectroscopy performance may be improved.

FIG. 10 is a cross-sectional view of an optical filter 1300 according to an example embodiment.

Referring to FIG. 10, the optical filter 1300 includes a plurality of, bandpass filters 511, 512, 513, 521, 522, 523, 531, 532, and 533 and a plurality of wideband filters 810, 820, and 830 on upper portions of the bandpass filters 511 to 533, wherein the plurality of bandpass filters 511 to 533 having different center wavelengths of light from one another are arranged in a predetermined pattern. Here, the plurality of bandpass filters 511 to 533 are the same as the plurality of bandpass filters 411 to 433 shown in FIG. 6.

FIG. 10 shows an example, in which nine bandpass filters 511 to 533 having different center wavelengths of light from one another are provided, and three bandpass filters having adjacent center wavelengths of light configure one filter array 510, 520, or 530.

The first filter array 510 may include the first to third bandpass filters 511, 512, and 513, and may transmit the light of first wavelength band. The second filter array 520 may include the fourth to sixth bandpass filters 521, 522, and 523, and may transmit the light of second wavelength band. The third filter array 530 may include the seventh to ninth bandpass filters 531, 532, and 533, and may transmit the light of third wavelength band.

The plurality of wideband filters 810, 820, and 830 are provided on upper portions of the plurality of bandpass filters 511 to 533. Here, each of the wideband filters 810, 820, and 830 may only transmit the light of a certain wavelength band.

The first wideband filter 810 is provided on an upper portion of the first filter array 510. The first wideband filter 810 may block the light of other wavelength bands than the first wavelength band that is the target of the first filter array 510. For example, when the first filter array 510 is the blue filter array transmitting the wavelength band of light of about 400 nm to 500 nm, the first wideband filter 810 may be a blue filter that transmits the wavelength band of blue light.

The second wideband filter 820 is provided on an upper portion of the second filter array 520. The second wideband filter 820 may block the light of other wavelength bands than the second wavelength band that is the target of the second filter array 520. For example, when the second filter array 520 is the green filter array transmitting the wavelength band of light of about 500 nm to 600 nm, the second wideband filter 820 may be a green filter that transmits the wavelength band of green light.

The third wideband filter 830 is provided on an upper portion of the third filter array 530. The third wideband filter 830 may block the light of other wavelength bands than the third wavelength band that is the target of the third filter array 530. For example, when the third filter array 530 is the red filter array transmitting the wavelength band of light of about 600 nm to 700 nm, the third wideband filter 830 may be a red filter that transmits the wavelength band of red light.

Each of the wideband filters 810, 820, and 830 may have, for example, a multi-cavity structure or a metal mirror structure.

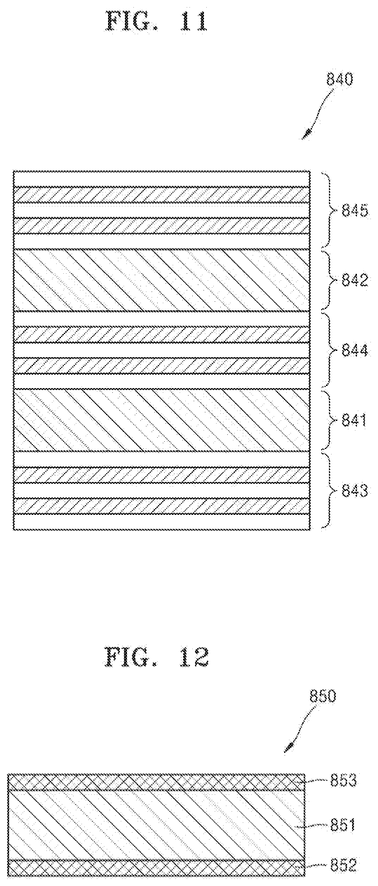

FIG. 11 shows an example of a wideband filter 840 of a multi-cavity structure. Referring to FIG. 11, the wideband filter 840 may include a plurality of reflective layers 843, 844, and 845 and a plurality of cavity layers 841 and 842 provided between the reflective layers 843, 844, and 845, wherein the plurality of reflective layers 843, 844, and 845 are spaced apart from one another. FIG. 11 shows three reflective layers 843, 844, and 845 and two cavity layers 841 and 842, but the number of reflective layers and the number of cavity layers may be variously modified.

For example, the first to third reflective layers 843, 844, and 845 are spaced apart from one another, the first cavity layer 841 may be provided between the first and second reflective layers 843 and 844, and the second cavity layer 842 may be provided between the second and third reflective layers 844 and 845.

Each of the first and second cavity layers 841 and 842 may have a material having a predetermined refractive index. Also, each of the first and second cavity layers 841 and 842 may include two or more materials having different refractive indices from each other.

Each of the first to third reflective layers 843, 844, and 845 may include a Bragg reflective layer. Each of the first to third reflective layers 843, 844, and 845 may have, for example, a structure in which a plurality of material layers having different refractive indices from one another are alternately stacked.

FIG. 12 shows an example of a wideband filter 850 having a metal mirror structure. Referring to FIG. 12, the wideband filter 850 may include first and second metal mirror layers 852 and 853 and a cavity layer 851 provided between the first and second metal mirror layers 852 and 853.

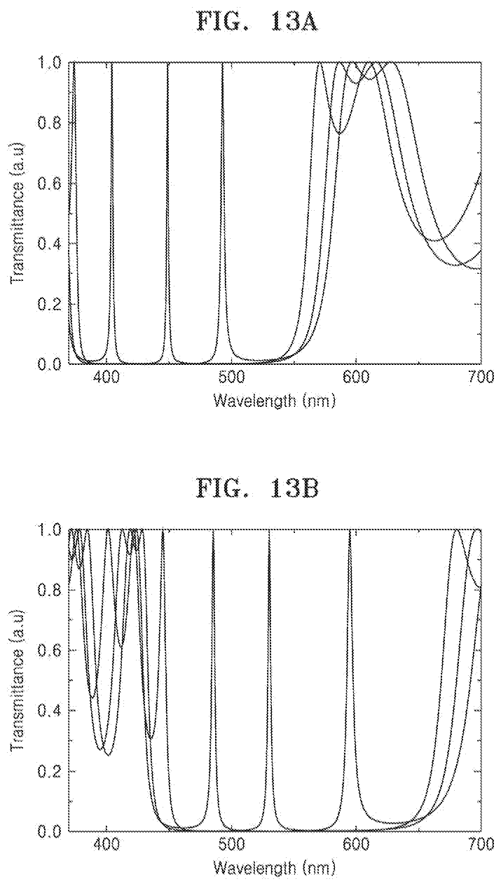

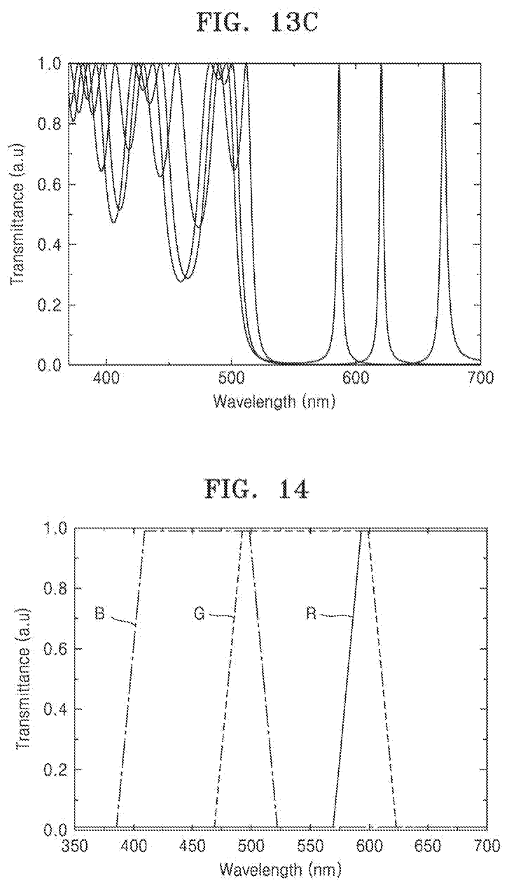

FIGS. 13A to 13C show transmission spectrums of the light passing through the first to third filter arrays 510, 520, and 530 of FIG. 10, as in FIGS. 7A to 7C.

FIG. 13A shows transmission spectrums of the light passing through the first filter array 510 in a case in which the first filter array 510 including the first to third bandpass filters 511, 512, and 513 of FIG. 10 is manufactured as the blue filter array that transmits the wavelength band of light of about 400 nm to 500 nm. FIG. 13B shows transmission spectrums of the light passing through the second filter array 520 in a case in which the second filter array 520 including the fourth to sixth bandpass filters 521, 522, and 523 of FIG. 10 is manufactured as the green filter array that transmits the wavelength band of light of about 500 nm to 600 nm. FIG. 13C shows a transmission spectrum of the light passing through the third filter array 530 in a case in which the third filter array 530 including the seventh to ninth bandpass filters 531, 532, and 533 of FIG. 10 is manufactured as the red filter array that transmits the wavelength band of light of about 600 nm to 700 nm. Referring to FIGS. 13A to 13C, it is understood the light of other wavelength bands than the wavelength bands that are the targets of the filter arrays has passed through the filter arrays.

FIG. 14 shows transmission spectrums of the light passing through the first to third wideband filters 810, 820, and 830 when the first to third wideband filters 810, 820, and 830 are respectively the blue, green, and red filters in FIG. 10. Here, the wideband filter having a multi-cavity structure is used as the wideband filter unit.

In FIG. 14, B, G, and R respectively denote the transmission spectrums of the light passing through the first, second, and third wideband filters 810, 820, and 830.

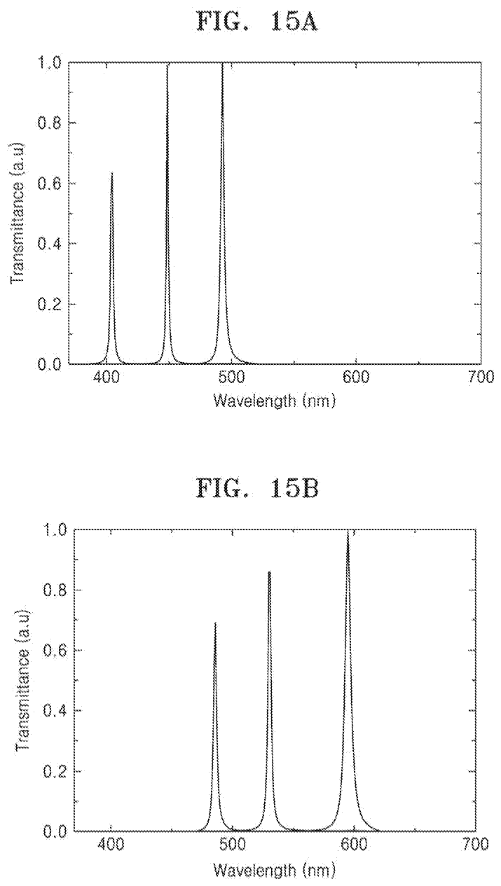

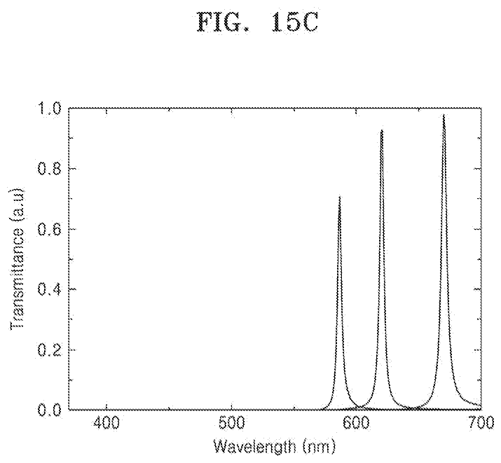

FIG. 15A shows transmission spectrums of the light passing through the first wideband filter 810 and the first filter array 510 when the first wideband filter (blue filter unit) 810 having the transmission spectrums shown in FIG. 14 is provided on the upper portion of the first filter array (blue filter array) 510 having the transmission spectrums shown in FIG. 13A. Referring to FIG. 15A, the light of other wavelength bands than the blue wavelength bands is blocked by the first wideband filter 810 and the light of the blue wavelength band is only incident to the first filter array 510, and thus the transmission spectrums of the first wavelength band of light that is the target of the first filter array 510 may be obtained.

FIG. 15B shows transmission spectrums of the light passing through the second wideband filter 820 and the second filter array 520 when the second wideband filter (green filter unit) 820 having the transmission spectrums shown in FIG. 14 is provided on the upper portion of the second filter array (green filter array) 520 having the transmission spectrums shown in FIG. 13B. Referring to FIG. 15B, the light of other wavelength bands than the green wavelength bands is blocked by the second wideband filter 820 and the light of the green wavelength band is only incident to the second filter array 520, and thus the transmission spectrums of the second wavelength band of light that is the target of the second filter array 520 may be obtained.

FIG. 15C shows transmission spectrums of the light passing through the third wideband filter 830 and the third filter array 530 when the third wideband filter (red filter unit) 830 having the transmission spectrums shown in FIG. 14 is provided on the upper portion of the third filter array (red filter array) 530 having the transmission spectrums shown in FIG. 13C. Referring to FIG. 15C, the light of other wavelength bands than the red wavelength bands is blocked by the third wideband filter 830 and the light of the red wavelength band is only incident to the third filter array 530, and thus the transmission spectrums of the third wavelength band of light that is the target of the third filter array 530 may be obtained.

As described above, the wideband filters 810, 820, and 830 that only transmit the light of certain wavelength bands are provided on the bandpass filters 511 to 533, and thus the light of desired wavelength bands may be only incident to the bandpass filters 511 to 533 and the spectroscopy performance may be improved.

According to the example embodiments, since the Bragg reflective layer includes three or more material layers having different refractive indices from one another, the width of the wavelength band of light passing through the bandpass filter may be variously adjusted. In addition, since the cavity layer in the bandpass filter has a thickness greater than λ/n, where, λ denotes a center wavelength of the bandpass filter and n denotes an effective refractive index of the cavity layer, dependency on the light incident angle may be reduced, and accordingly, the light having a certain center wavelength of a desired intensity may be transmitted even when the light is incident to the bandpass filter at various angles.

In addition, the color filters that only transmit the light of certain wavelength bands are provided on the bandpass filters so that the light of the desired wavelength band may be incident to the bandpass filters, and accordingly, the spectroscopy performance may be improved.

It should be understood that embodiments described herein should be considered in a descriptive sense only and not for purposes of limitation. Descriptions of features or aspects within each embodiment should typically be considered as available for other similar features or aspects in other embodiments.

While example embodiments have been described with reference to the figures, it will be understood by those of ordinary skill in the art that various changes in form and details may be made therein without departing from the spirit and scope as defined by the following claims.

What is claimed is:

1. An optical filter comprising:
a plurality of bandpass filters having center wavelengths of light that are different from one another,
wherein each of the plurality of bandpass filters comprises:
a cavity layer;
a first Bragg reflective layer provided on an upper surface of the cavity layer; and
a second Bragg reflective layer provided on a lower surface of the cavity layer opposite to the upper surface,
wherein the cavity layer has a thickness greater than λ/n, where λ is a center wavelength of light of each of the plurality of bandpass filters and n is an effective refractive index of the cavity layer, and
wherein each of the first Bragg reflective layer and the second Bragg reflective layer comprises three or more material layers having different refractive indices from one another.

2. The optical filter of claim 1, wherein the cavity layer comprises one material layer or a plurality of material layers having different refractive indices from one another.

3. The optical filter of claim 2, wherein the plurality of material layers are arranged horizontally or vertically.

4. The optical filter of claim 2, wherein the plurality of material layers are arranged one-dimensionally or two-dimensionally.

5. The optical filter of claim 1, wherein each of the first Bragg reflective layer and the second Bragg reflective layer comprises a first material layer comprising silicon, a second material layer comprising silicon oxide, and a third material layer comprising titanium oxide or titanium nitride.

6. The optical filter of claim 1, further comprising a plurality of additional filters provided on the plurality of bandpass filters, the plurality of additional filters being configured to transmit light of certain wavelength bands, respectively.

7. The optical filter of claim 6, wherein the plurality of additional filters comprise a plurality of color filters.

8. The optical filter of claim 6, wherein the plurality of additional filters comprise a plurality of wideband filters.

9. The optical filter of claim 8, wherein each of the plurality of wideband filters has a multi-cavity structure or a metal mirror structure.

10. The optical filter of claim 6, wherein each of the plurality of additional filters corresponds to at least one of the plurality of bandpass filters.

11. An optical filter comprising:
a plurality of bandpass filters having center wavelengths of light that are different from one another,
wherein each of the plurality of bandpass filters comprises:
a cavity layer;
a first Bragg reflective layer provided on an upper surface of the cavity layer; and
a second Bragg reflective layer provided on a lower surface of the cavity layer opposite to the upper surface, and
wherein the cavity layer has a thickness greater than λ/n, where λ is a center wavelength of light of each of the plurality of bandpass filters and n is an effective refractive index of the cavity layer.

12. The optical filter of claim 11, further comprising a plurality of additional filters provided on the plurality of bandpass filters, the plurality of additional filters configured to transmit light of certain wavelength bands, respectively.

13. The optical filter of claim 12, wherein the plurality of additional filters comprise a plurality of color filters or a plurality of wideband filters.

14. A spectrometer comprising:
an optical filter comprising a plurality of bandpass filters having center wavelengths of light that are different from one another; and
a sensing device configured to receive light transmitted through the optical filter,
wherein each of the plurality of bandpass filters comprises:
a cavity layer;
a first Bragg reflective layer provided on an upper surface of the cavity layer; and
a second Bragg reflective layer provided on a lower surface of the cavity layer opposite to the upper surface,
wherein the cavity layer has a thickness greater than λ/n, where λ is a center wavelength of light of each of the plurality of bandpass filters and n is an effective refractive index of the cavity layer, and
wherein each of the first Bragg reflective layer and the second Bragg reflective layer comprises three or more material layers having different refractive indices from one another.

15. The spectrometer of claim 14, wherein the optical filter further comprises a plurality of additional filters provided on the plurality of bandpass filters, the plurality of additional filters being configured to transmit certain wavelength bands of light, respectively.

16. The spectrometer of claim 15, wherein the plurality of additional filters comprise a plurality of color filters or a plurality of wideband filters.

17. The spectrometer of claim 14, wherein the sensing device comprises an image sensor or a photodiode.

18. A spectrometer comprising:
an optical filter comprising a plurality of bandpass filters having center wavelengths of light that are different from one another; and
a sensing device configured to receive light transmitted through the optical filter,
wherein each of the plurality of bandpass filters comprises:
a cavity layer;
a first Bragg reflective layer provided on an upper surface of the cavity layer; and
a second Bragg reflective layer provided on a lower surface of the cavity layer opposite to the upper surface, and
wherein the cavity layer has a thickness greater than λ/n, where λ denotes a center wavelength of light of each of the plurality of bandpass filters and n is an effective refractive index of the cavity layer.

19. The spectrometer of claim 18, wherein the optical filter further comprises a plurality of additional filters provided on the plurality of bandpass filters, the plurality of additional filters configured to transmit certain wavelength bands of light, respectively.

20. The spectrometer of claim 19, wherein the plurality of additional filters comprise a plurality of color filters or a plurality of wideband filters.

21. The optical filter of claim 2, wherein the plurality of material layers comprise a first material layer and a second material layer that are alternately provided horizontally, and a refractive index of the first material layer is different from a refractive index of the second material layer.

22. The optical filter of claim 2, wherein the plurality of material layers comprise a first material layer and a second material layer that are alternately provided vertically, and a refractive index of the first material layer is different from a refractive index of the second material layer.

23. The optical filter of claim 10, wherein three adjacent bandpass filters among the plurality of bandpass filters are included in a filter array, and
wherein each of the plurality of additional filters correspond to the filter array.
